(19) United States
(12) Patent Application Publication
(10) Pub. No.: US 2009/0065540 A1
(43) Pub. Date: Mar. 12, 2009

(54) APPARATUS FOR SUSPENDING AN ELECTRONIC DEVICE BETWEEN THE REAR SIDES OF AN AIRPLANE SEAT

(76) Inventor: Tina Pantoja, Houston, TX (US)

Correspondence Address: CLARENCE E. ERIKSEN & ASSOCIATES, P.C., NINE GREENWAY PLAZA, SUITE 3100, HOUSTON, TX, 77046-0904, US

(21) Appl. No.: 11/851,877

(22) Filed: Sep. 7, 2007

(51) Int. Cl. B60R 7/04

(52) U.S. Cl. 224/275

(57) ABSTRACT

Apparatus is disclosed for use in suspending an electronic device between the rear sides of a seat in an airplane. The apparatus comprises a receptacle for receiving the electronic device, and a strip of elastic material which is in operative engagement with the receptacle. The strip of elastic materials has first and second ends with gripping mechanisms at each end for engagement with the rear side portions of the airplane seat. The apparatus may further comprise a tilting mechanism for adjusting the position of the electronic device.

### BACKGROUND OF THE INVENTION

1. Field of the Invention

The present invention relates to apparatus for suspending an electronic device between the rear sides of a seat in an airplane.

2. Description of the Prior Art

Portable electronic devices for storing and playing music or video materials presently enjoy a high popularity among persons of many age groups. It is common to see such portable electronic devices being used in a variety of situations, one of which is an airplane. A disadvantage of using such devices on an airplane is that one must hold the device during uses. This is especially true in the case of a female traveler who typically has no pockets on her blouse.

Various approaches have been proposed to suspend electronic devices so that they may be enjoyed while traveling. Such approaches are, for example, disclosed in U.S. Pat. Nos. 6,932,309, 6,216,927, 6,092,705, and U.S. Publication Nos. 20070120038, 20060226322, 20060022003, 20050218172, 20040026966, and 20010011664. None of these prior approaches has resulted in a satisfactory solution for suspending an electronic device so that it does not have to be held while riding on an airplane. That novel and useful result has been realized by the present invention.

### SUMMARY OF THE INVENTION

Apparatus for use in suspending an electronic device between the rear sides of a seat in an airplane comprises a receptacle for receiving the electronic device. The apparatus further comprises a strip of elastic material which has first and second ends and which is in operative engagement with the receptacle. Gripping mechanisms are operatively connected to the two ends of the elastic strip for engagement with the side portions of the rear of an airplane seat.

The apparatus of the present invention may further comprise the electronic device, which, in one embodiment, comprises an iPod device.

In one embodiment, the gripping devices are operatively connected to the fast and second ends using extension springs, while in other embodiments no such springs are utilized.

Apparatus in accordance with the present invention may further comprise a tilting device to change the position of the electronic device if the seat from which it is suspended is reclined.

### BRIEF DESCRIPTION OF THE DRAWINGS

In the accompanying drawings:

FIG. 1 is a front elevation view of one embodiment of apparatus in accordance with the present invention.

FIG. 1A is a cross-sectional view of the apparatus of FIG. 1 taken along the line 1A-1A in FIG. 1.

FIG. 2 is a front elevation view of components comprising a second embodiment of apparatus in accordance with the present invention.

FIG. 3 is a front elevation view of an alternative gripping mechanism to that shown in FIGS. 1 and 2.

FIG. 4 is a front elevation view of another embodiment of apparatus in accordance with the present invention.

FIG. 5 is an elevation view illustrating apparatus of the present invention utilized to suspend an electronic device between the rear sides of an airplane seat.

FIG. 6 is a perspective view of clip 108 of FIG. 2 which illustrates a tilting device 108B.

### DETAILED DESCRIPTION

It will be appreciated that the present invention may take many forms and embodiments. In the following description, some embodiments of the invention are described and numerous details are set forth to provide an understanding of the present invention. Those skilled in the art will appreciate, however, that the present invention may be practiced without those details and that numerous variations and modifications from the described embodiments may be possible. The following description is thus intended to illustrate and not to limit the present invention.

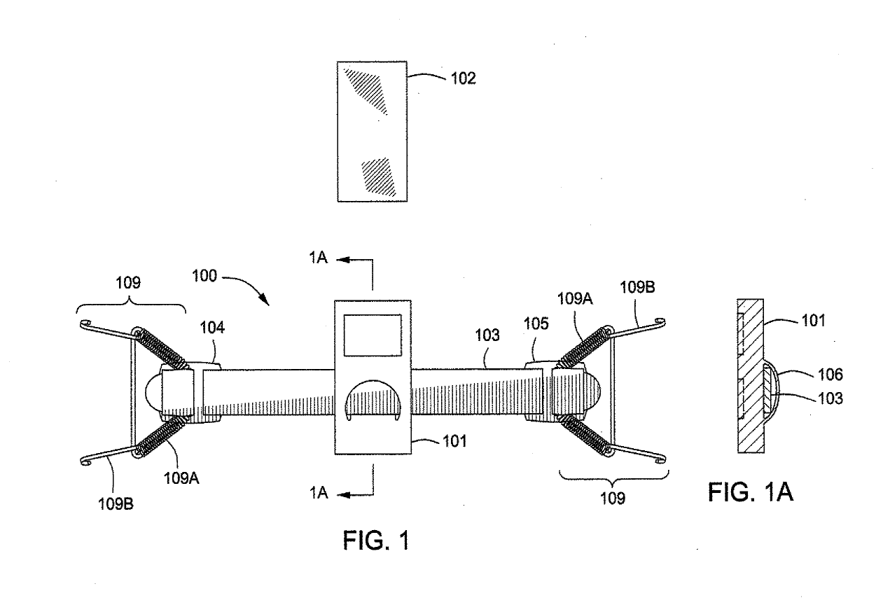

With reference first to FIG. 1, apparatus 100 in accordance with the present invention is illustrated. Apparatus 100 comprises a receptacle 101 for receiving an electronic device 102. Apparatus 100 further comprises a strip of elastic material 103 which has first and second ends 104 and 105, respectively, and which is in operative engagement with receptacle 101. Such operative engagement may, for example, be realized by forming one or more belt-type loops 106 in receptacle 101 and passing the strip of elastic material 103 through loops 106, as illustrated in FIGS. 1 and 1A.

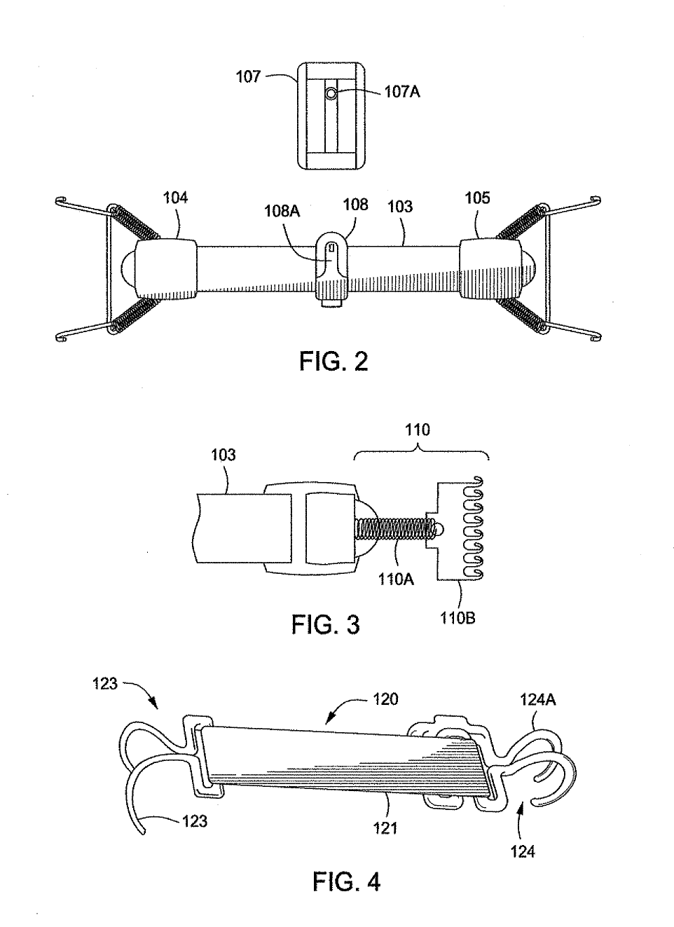

By way of further example, operative engagement between elastic material 103 and a receptacle 107 and elastic strip 103 may be realized by utilizing clip 108 which attaches to elastic material 103. Clip 108 contains a slot portion 108A for engagement with a circular portion 107A on receptacle 107, as illustrated in FIG. 2. The embodiment of FIG. 2 permits the user to rotate receptacle 107 to a desired position.

With reference again to FIG. 1, apparatus 100 further comprises a gripping mechanism which is operatively connected to each end 104, 105 of elastic strip 103. In FIG. 1, gripping mechanism 109 comprises extension springs 109A, to which are attached hook apparatus 109B. In FIG. 3, gripping mechanism 110 comprises a gripping end 110B having a plurality of tooth-like structures which is operatively connected to elastic material 103 using extension spring 110A.

Referring now to FIG. 4, apparatus 120 according to the present invention is illustrated. Apparatus 120 comprises elastic material 121 and gripping mechanisms 123 and 124 which elastic material 121 engages and which comprises gripping members 123A and 124A. A receptacle for an electronic device, such as receptacle 107 of FIG. 2, may operatively engage the elastic material 121 utilizing a clip such as clip 108 of FIG. 2.

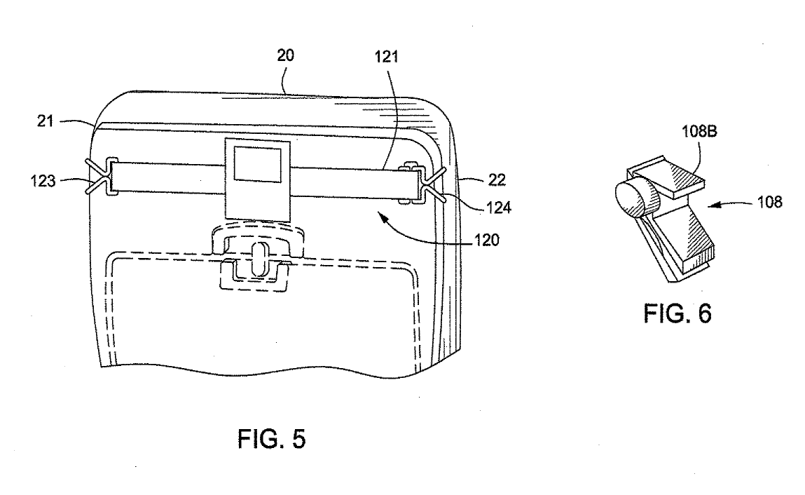

With reference to FIG. 5, the apparatus 120 of FIG. 4 may be installed between the rear sides 21 and 22 of an airplane seat 20 by extending elastic material 121 and utilizing gripping mechanisms 123 and 124A to engage the sides 21 and 22 of the seat 20.

If extensive springs are employed the initial tension of the extension springs in the embodiments of FIGS. 1 and 3 may be selected to insure that the gripping ends 109B and 110B securely engage rear sides 21 and 22 of seat 20. In the embodiment of FIG. 3, extension spring 110A may not be needed, if the tension in elastic strip 103 is sufficiently high so that the gripping ends 110A securely engage the rear sides 21 and 22 of seat 20.

With reference to FIG. 6, clip 108 may, for example, include tilting mechanism 108B for adjusting the position of the electronic device if the seat from which the electronic device is suspended is reclined.

An electronic device 102 may be installed in the receptacle 105 or 107. In one embodiment of the present invention, the electronic device comprises an iPod device.

What is claimed is:

1. Apparatus for permitting a user to suspend an electronic device between the rear sides of a seat in an airplane, comprising:
a receptacle for receiving the electronic device;
a strip of elastic material which has first and second ends and which is in operative engagement with the receptacle; and
gripping mechanisms operatively connected to the first and second ends, respectively, of the elastic material for engagement with the side portions of the airplane seat.

2. The apparatus of claim 1, further comprising an electronic device which is installed in the receptacle.

3. The apparatus of claim 2, wherein the electronic device is an iPod device.

4. The apparatus of claim 1, wherein the gripping mechanisms are operatively connected to the first and second ends of the elastic material by spring elements.

5. The apparatus of claim 1, wherein the receptacle comprises a clip which operatively engages the strip of elastic material.

6. The apparatus of claim 5, wherein the clip comprises apparatus for permitting the user to rotate the position of the receptacle.

7. The apparatus of claim 5, wherein the clip comprises a tilting mechanism for adjusting the position of the electronic device.
